(19) United States
(12) Patent Application Publication
(10) Pub. No.: US 2019/0322328 A1
(43) Pub. Date: Oct. 24, 2019

(54) VEHICLE

(71) Applicant: Koofy Innovation Limited, Central (CN)

(72) Inventors: Ondy Song Qi MA, Hong Kong (CN); Bengt IVARSSON, Hong Kong (CN)

(21) Appl. No.: 16/392,511

(22) Filed: Apr. 23, 2019

Related U.S. Application Data
(60) Provisional application No. 62/661,405, filed on Apr. 23, 2018.

(51) Int. Cl. B62K 3/10; B62K 21/00; B62K 3/00; B62M 6/90; B62M 6/40; B62M 7/04

(52) U.S. Cl. CPC B62K 3/10; B62K 21/005; B62K 3/002; B62K 2202/00; B62M 6/40; B62M 7/04; B62M 6/90

(57) ABSTRACT

In an aspect, an electrical vehicle for traveling in a forward direction has two wheels on opposing side of a platform without a steering column. A motor and a battery are adapted to drive one wheel and controlled via a fold-out foot control. The steering wheel is controlled via a fold-out foot control. Both the driving wheel and the steering can also be controlled remotely by radio, smartphone app or the like. The two fold-out foot controls are integrated into the general shape of the platform when not in use. The vehicle is equipped with lateral balancing means and connected to a network, which enables it to be driven autonomously.

### CROSS-REFERENCE TO RELATED APPLICATIONS

This application claims the benefit of U.S. Provisional Application 62/661,405, filed on Apr. 23, 2018, the contents of which are incorporated herein by reference in their entirety.

### FIELD

The present invention relates to vehicles for personal transportation, particularly two-wheeled motorized scooters.

### BACKGROUND OF THE DISCLOSURE

Two-wheeled scooters are commonly seen nowadays, some with and some without motor. Typically, such scooters have a generally horizontal, elongate footplate with front and rear wheels and a vertical steering column with handle bars. The steering column, which usually accounts for half the weight of the vehicle, is typically used for several purposes: first, for steering; second, for helping the rider of the vehicle to balance the vehicle sideways; third, in the case of motorized scooters, to control the speed via a hand control; and fourth, for hand-braking. The wheels on such two-wheeled scooters are typically located one in front of the other at opposite ends of the footplate, where the steering column is connected to the front wheel. Problems exist with some of these vehicles. For example, they can be heavy and awkward to carry when not in use. Also, they restrict the position of the rider in the sense that the rider generally must keep at least one hand on the handlebar in order to maintain stability and to control the vehicle's speed, during use. Improvements to such vehicles would be desirable.

### SUMMARY OF THE DISCLOSURE

In an aspect, disclosed herein is a two-wheeled motorised scooter that is free of a steering column but which has a front wheel that is steered.

A difference between two-wheeled vehicles and vehicles with three or more wheels, is that, at low or zero speeds, a two wheeled vehicle normally requires a support to remain upright. It is different for example for a four wheeled vehicle such as a car which can always remain upright, but requires hand controls for steering and foot supports for controlling the speed. In a similar way a four-wheeled skateboard can always remain upright but requires energetic input from the rider to a flexible steering joint (a lean-to-steer joint that is part of each skateboard truck). Boards like the Yii and Ripstick have a fish-tail type of steering joint which are easier to activate but also requires a certain speed in order to work. Additionally, there are two-wheeled self-balancing vehicles (e.g. a Segway), which can keep itself upright but requires input from hand controls for steering.

In another aspect, the present disclosure relates to an electric vehicle, which includes a steering wheel, a driving wheel and a platform connecting the steering wheel and the driving wheel, a motor and a power source connected to the driving wheel, a steering control for controlling the steering wheel, and a speed control for controlling the rotation of the driving wheel. The steering mechanism is operated by a first foot support.

In yet another aspect, an electric vehicle is provided, which includes a body, a plurality of wheels including at least one front wheel and at least one rear wheel, a motor that is operatively connected to at least one of the plurality of wheels, and at least one battery for storing power to be sent to the motor to drive the at least one of the plurality of wheels. The body includes a main body portion, a first foot support and a second foot support. The first and second foot supports each are positionable in a stowage position wherein each of the first and second foot supports have a width that is less than two times a width of the main body portion, and a use position in which each of the first and second foot supports have a width that is greater than the width of the first and second foot supports when in the stowage position.

In yet another aspect, an electric vehicle is provided, which includes a body including a main body portion, a first foot support supported on the main body portion, and a second support positioned aft of the first foot support and supported on the main body portion, a plurality of wheels including at least one front wheel and at least one rear wheel, a motor that is operatively connected to at least one of the plurality of wheels, at least one battery for storing power to be sent to the motor to drive the at least one of the plurality of wheels, a balancing drive that includes at least one CMG and/or at least one reaction wheel, at least one balance sensor that outputs signals based on the orientation of the scooter, and a control system that is programmed to control balance of the scooter based on signals from the at least one balance sensor.

In yet another aspect, an electric vehicle is provided and includes a body including a main body portion, a first foot support supported on the main body portion, and a second support positioned aft of the first foot support and supported on the main body portion, a plurality of wheels including at least one front wheel and at least one rear wheel, a motor that is operatively connected to at least one of the plurality of wheels, and at least one battery for storing power to be sent to the motor to drive the at least one of the plurality of wheels. The first foot support is pivotable relative to the main body portion about a generally vertical axis, and is connected to the at least one front wheel via a steering arrangement, such that pivoting of the first foot support in a first foot support pivot direction pivots the at least one front wheel in a first front wheel pivot direction, and pivoting of the first foot support in a second foot support pivot direction that is opposite the first foot support pivot direction, pivots the at least one front wheel in a second front wheel pivot direction that is opposite the first front wheel pivot direction.

In another aspect, disclosed herein is a two-wheeled motorized scooter that can remain upright without input from a rider.

The four-wheel skateboard, the car and other vehicles with three or more wheels, and, to a certain extent, self-balancing vehicles such as the Segway, have the capability to be driven remotely or autonomously via remote control or a program. This is because of their inherent stability (for vehicles with three or more wheels) or their ability to self-balance in order to remain upright at low speed or while stationary (for vehicles such as the Segway).

In yet another aspect, disclosed herein is a two-wheeled motorised and autonomous scooter.

In yet another aspect, disclosed herein is a motorised scooter without hand controls.

In yet another aspect, disclosed herein is a scooter having at least one foot support that is moveable between a stowage position in which the foot support is generally parallel with the platform, and a second position in which the foot support is generally perpendicular to the stowage position and extends laterally on either side of the platform so that the rider can place their foot on it in a transverse orientation to the longitudinal axis of the platform.

One or more of the following technical problems can be resolved by different elements of the present disclosure:

the problem of steering a motorised scooter without a steering column;

the problem of controlling the speed of a motorised scooter without hand controls;

the problem of making a scooter remain upright at low or zero speed without support;

the problem of making a scooter an autonomous vehicle; and

the problem of making a scooter generally compact.

One or more of the following advantages can be achieved via different elements of the present disclosure:

the vehicle can be steered without using hand controls or a handlebar;

the vehicle can keep its balance (i.e. remain upright, balanced on the two wheels) even at low or zero speed;

the vehicle can remain upright when parked, without support;

the vehicle can be made autonomous, (i.e. self-driving); and

the vehicle can be compact and light and easier to carry by the rider prior to or after use.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 is a perspective view of a scooter in accordance with an embodiment of the present disclosure, with foot pads in a stowage position;

FIG. 2 is a perspective view of the scooter shown in FIG. 1, with the foot pads in a first intermediate position;

FIG. 3 is a perspective view of the scooter shown in FIG. 1, with the foot pads in a second intermediate position;

FIG. 4 is a perspective view of a portion of the scooter shown in FIG. 1, with the foot pads in a use position;

FIG. 4A is a perspective view of a portion of the scooter shown in FIG. 1, with an alternative foot support;

FIG. 5 is a perspective view of a steering arrangement for the scooter shown in FIG. 1;

FIG. 6 is a perspective view of the scooter shown in FIG. 1, with a housing removed so as to show components therein;

FIG. 7 is another perspective view of the scooter shown in FIG. 1, with the housing removed so as to show components therein;

FIG. 8 is a bottom plan view of a portion of the scooter shown in FIG. 1;

FIG. 9 is a transparent top plan view showing the front wheel of the scooter shown in FIG. 1, being pivoted in a first pivot direction; and

FIG. 10 is a transparent top plan view showing the front wheel of the scooter shown in FIG. 1, being pivoted in a second pivot direction.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

A scooter 10 is shown in the figures. The scooter 10 includes a scooter body 12, at least one front wheel 14 and at least one rear wheel 16. In one embodiment, the scooter 10 is motorized. For example, an electric hub motor 18 may be provided inside the rear wheel 16.

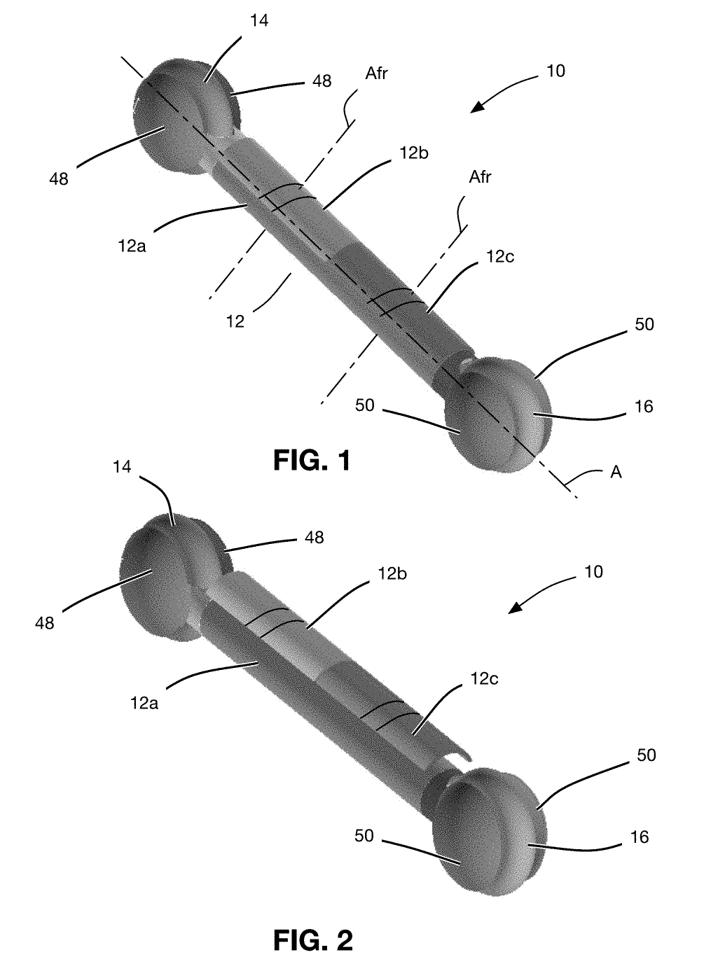

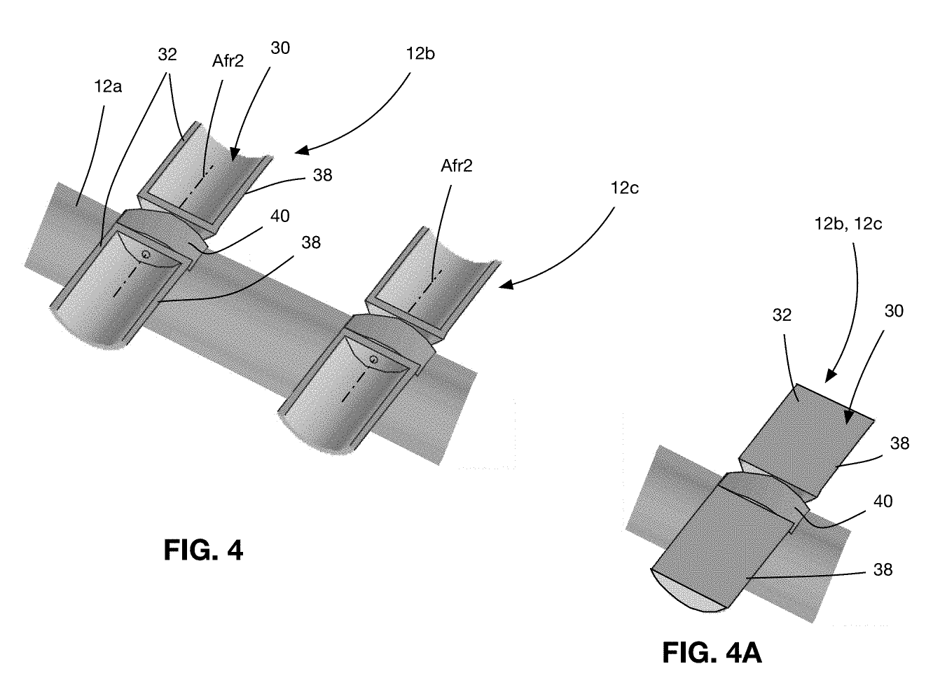

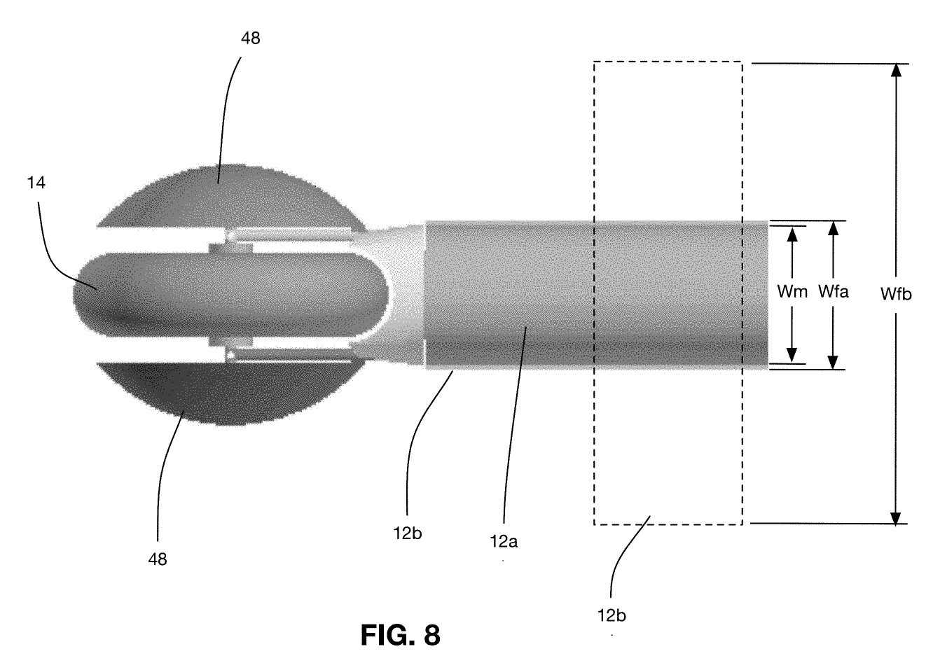

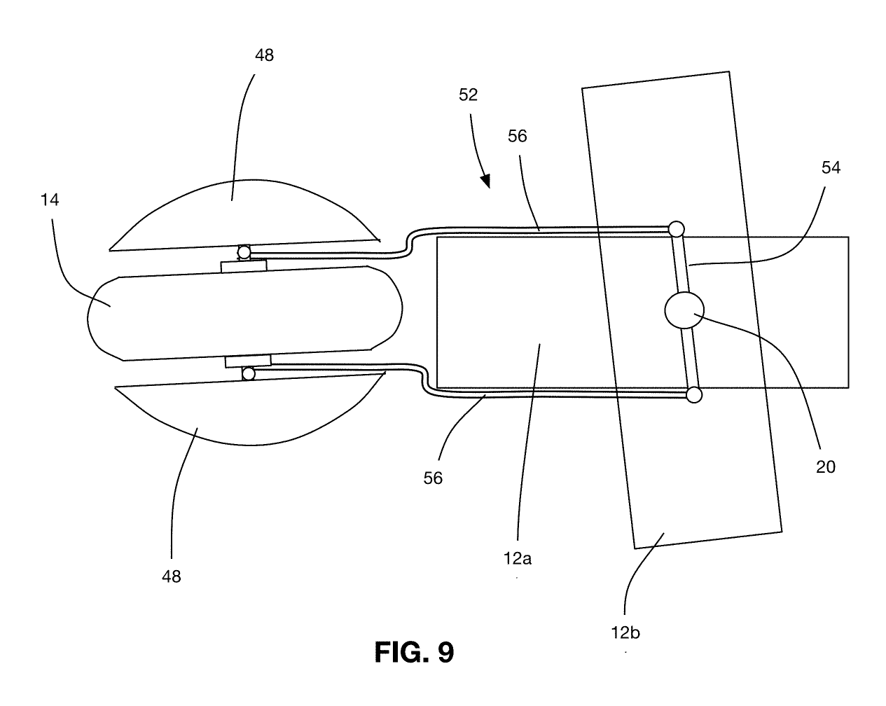

The scooter body 12 may have a main body portion 12a, a first foot support 12b and a second foot support 12c. The first and second foot supports 12b and 12c are mounted to the main body portion 12a and are movable between a stowage position shown in FIG. 1 and a use position shown in FIG. 4. In the stowage position the first and second foot supports 12b and 12c are oriented to have a width Wfa that is approximately the same as a width Wm of the main body portion 12a. In some embodiments the width Wfa may be less than about 2 times the width Wm of the main body portion 12a. The width is generally the dimension that is laterally transverse to the direction of motion of the scooter 10, and is therefore laterally transverse to the longitudinal axis A of the scooter 10, which is parallel to the direction of motion of the scooter. The widths Wfa and Wm are shown in FIG. 8. In the use position shown in FIG. 4, each of the first and second foot supports 12b and 12c are oriented such that its width Wfb, is greater than the width Wfa when it is in the stowage position. The foot support 12b is shown in the use position in broken lines in FIG. 8 to provide a direct comparison between Wfb and Wfa.

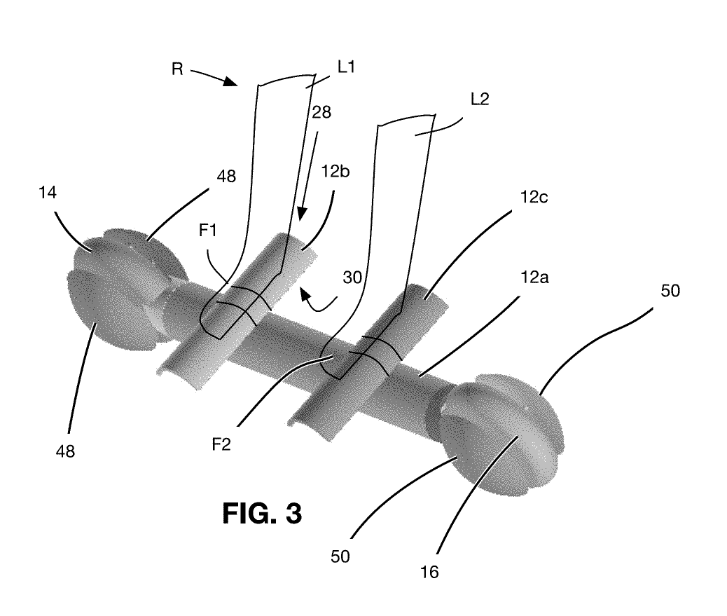

In the use position, each foot support 12b, 12c is oriented to hold a foot of a rider (identified at R, and whose first and second legs L1 and L2 and first and second feet F1 and F2 are shown schematically in FIG. 3) in a laterally oriented position, (e.g. akin to the orientation that the rider would have when riding on a skateboard, where their body generally faces left or right relative to the longitudinal axis of the skateboard). In some preferred embodiments the width Wfb is greater than the length of a foot of the target rider. In some preferred embodiments the width Wfb is greater than or equal to the length of a foot of the 95^{th} percentile height of the target rider. Thus, if the target rider for the scooter 10 is an adult male from the United States, the width Wfb may be longer than about 11 inches. It will be understood that the width Wfb of each foot support 12b, 12c when in the use position may be less than this aforementioned length of a foot of a 95^{th} percentile height rider, since the foot support 12b, 12c can support the rider comfortably even when it is shorter than this value. In general the terms width used in the present disclosure refer to width in the lateral direction (i.e. in a direction that is transverse relative to the longitudinal axis of the scooter 10). The widths herein may thus be referred to as lateral widths.

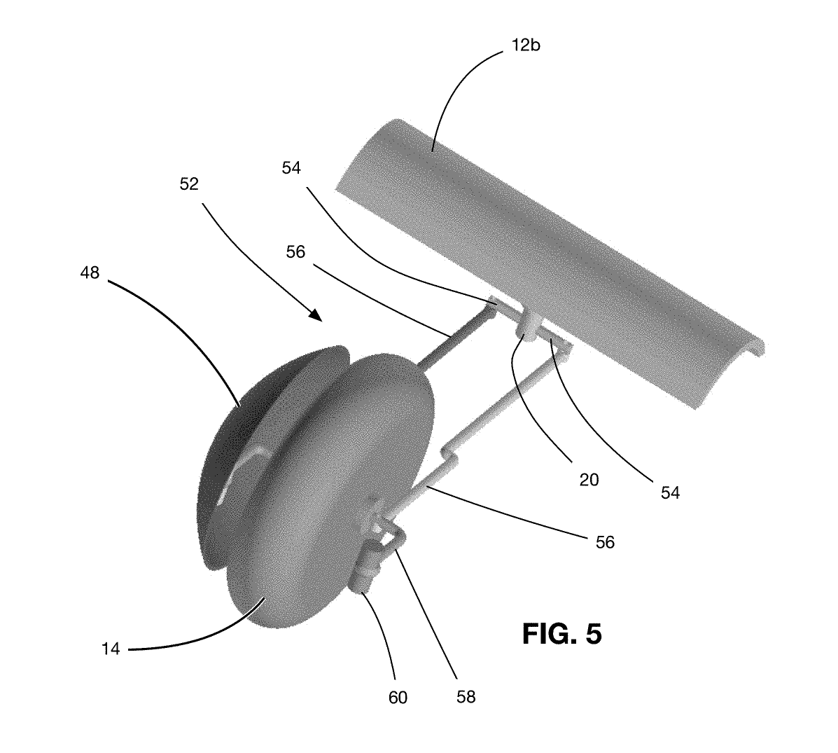

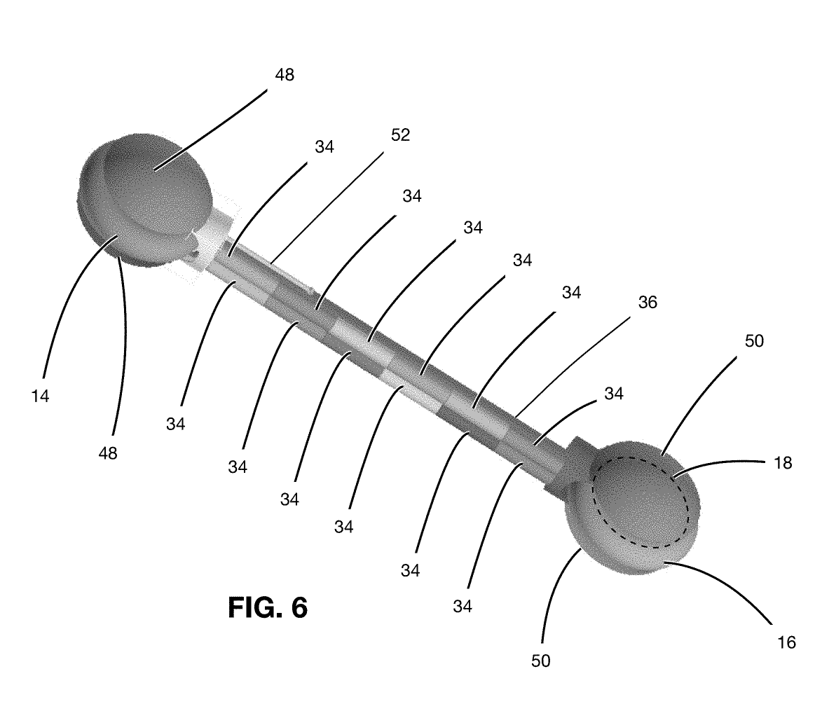

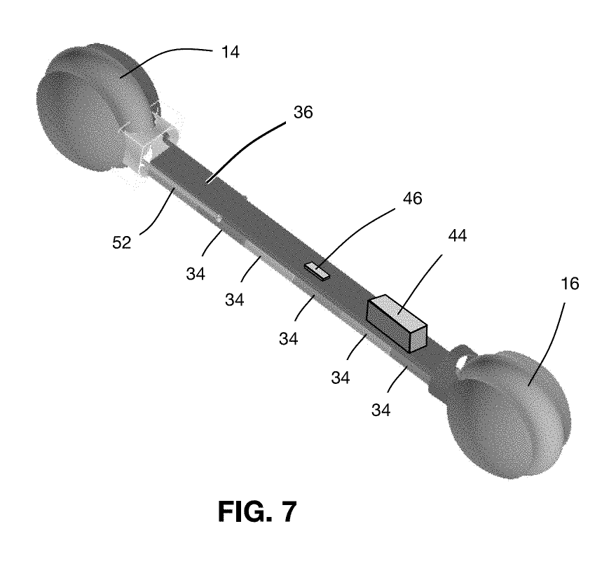

The movement of the foot supports 12b, 12c from the stowage position to the use position may proceed as follows. While the foot supports 12b, 12c, are in the stowage position, they may be locked in place preventing them from being rotated about their vertical axes (shown at Afr). Each foot support 12b, 12c may be lifted upwards away from the main body portion 12a to a first intermediate position shown in FIG. 2. A stem shown at 20 in FIG. 5 extending from the foot support 12b, 12c may extend downwards into the main body portion 12a and may be biased (e.g. via a compression spring, not shown acting on a flange on the stem 20 and against an inside wall of the main body portion) to keep the foot support 12b, 12c engaged against the main body portion 12a. Once lifted, the foot support 12b, 12c is free to turn about its axis Afr. The amount of rotation may be 90 degrees. The stem 20 of each foot support 12b, 12c may include one or more ball plungers and the main body portion 12a may include detents that hold the foot support 12b, 12c once it reaches the correct rotation. Once rotated, if there is any play, the rider may let go of foot support 12b, 12c and the biasing spring would bring it back into engagement with the main body portion 12a to reach a second intermediate position, as shown in FIG. 3.

The foot supports 12b and 12c each have a first side 28 and a second side 30. In some embodiments, the first side 28 may be the side that the rider places their feet on when standing on the scooter 10. In such embodiments, the foot support surface (shown at 32) of the foot supports 12b, 12c is on the first side 28. In such a case, the position shown in FIG. 3 is not a second intermediate position but is instead the use position. Alternatively, in some embodiments (including the embodiment shown in the present figures), the second side 30 has the foot support surface 32 thereon and is facing downwards while the foot support 12b, 12c is in the position shown in FIG. 3. From this position, the rider can rotate wing portions 38 of the foot support 12b, 12c about a lateral axis Afr2 relative to a central portion 40 until the foot support surface 32 faces upwards, as shown in FIG. 4. The position in FIG. 4 is the use position in this embodiment. This provides the rider with a relatively flat foot support surface 32 when riding the scooter 10.

The wing portions 38 may optionally be lockable in the position shown in FIG. 4 via ball plungers on the central portion 40 that engage detents on the wing portions 38. The wing portions 38 may be connected to a common shaft through the central portion 40 so that the wing portions 38 pivot together about the axis Afr.

As can be seen, the second side 30 of the foot support 12b, 12c may be largely hollow so as to avoid consuming too much room from the main body portion 12a, which houses many other components of the scooter 10.

Alternatively, however it is possible for the second side 30 of the foot support 12b, 12c to be filled so that it is flat across its entirety, as shown in FIG. 4A, though it will consume more of the room that would otherwise be occupied the main body portion 12a.

As noted above, the main body portion 12a houses many components of the scooter 10. Thus the main body portion 12a forms a housing for these components. In an example, the batteries, shown at 34, which provide power to the motor 18 are housed in the main body portion 12a. The batteries 34 are preferably rechargeable and may be charged by any means known in the art.

Additionally, a control system that includes a controller 36 may be housed in the main body portion 12a. The controller 36 controls operation of the motor 18 and other electronic components of the scooter 10. A balancing drive 44 may be included in the main body portion 12a. The balancing drive 44 may be any suitable type of balancing device such as an arrangement of one or more CMGs (controlled moment gyroscopes) or an arrangement of one or more reaction wheels. The controller 36 may receive input from one or more balance sensors 46 (e.g. accelerometers) and may control the balancing drive 44 in order to maintain the scooter 10 in an upright position. It will be noted that the scooter 10 is therefore capable of keeping itself upright without the need to control the steering angle of whichever of the front and rear wheels 14 and 16 steers the scooter 10 (i.e. the front wheel 14 in the present example). In other embodiments, however, the balancing drive 44 may be made up of one or more motors that does control the steering angle of whichever of the front and rear wheels 14 and 16 steers the scooter 10.

Speed control for the scooter 10 may be provided by means of a speed control input device, which may be the second foot support 12c. the second foot support 12c may be configured to sense pressure or may be configured to sense pivoting or some other interaction with the second foot F2 of the rider R and may be configured to communicate this interaction to the controller 36. The communication may be for example wireless communication (e.g. by a Bluetooth connection between the second foot support 12c and the controller 36) or it may be any other suitable connection such as a wired connection.

The main body portion 12a includes wheel covers shown at 48 and 50 to cover the inner portions of the front and rear wheels 14 and 16.

The front wheel 14 is shown as the wheel that is steerable on the scooter 10 and may thus be referred to as the steering wheel. The steering wheel may be steered by any suitable structure. In order to steer the scooter 10 shown in the figures the first foot support 12b (i.e. the front foot support) is operatively connected to the front wheel 14 via a steering arrangement 52 shown in FIG. 5. The first foot support 12b in FIG. 5 has a use position that is shown with the first side 28 as the foot engagement surface 32. However, it is also possible for the first foot support 12b to be as shown in FIG. 4 or 4A when in the use position.

The stem 20 is shown extending down from the front foot support 12b. The steering arrangement 52 includes first and second stem arms 54 that extend laterally outward from the stem 20. The first and second stem arms 54 are pivotally connected to first and second steering links 56, which are pivotally connected to a steering wheel shaft 58. The steering wheel (i.e. the front wheel 14) is rotatably supported on the steering wheel shaft 58. In other works the steering wheel rotates on the shaft 58 during rolling of the scooter 10 on the ground. The shaft 58 is pivotally connected at its outer ends to the main both portion 12a, and more specifically to the front wheel covers 48.

Pivoting of the front foot support 12b about the vertical axis Afr, moves the stem arms 54, which in turn causes one of the steering links 56 to move rearwardly and the other of the steering links 56 to move forwardly. This in turn causes the front wheel 14 to pivot about a steering wheel pivot axis, so as to turn towards the left or right, depending on which steering link 56 moved rearwardly and which moved forwardly.

It will be noted that the front wheel 14 is connected to the main body portion 12a via two pivotal connections at 60 with the front wheel covers 48. The two pivotal connections 60 are positioned forward of the axis of rotation of the front wheel 14.

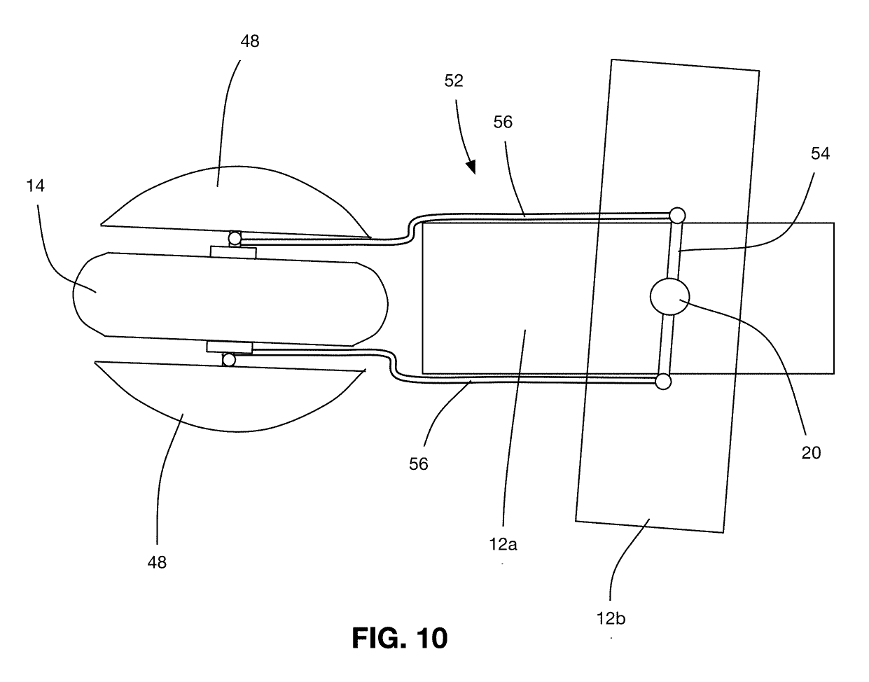

FIG. 9 shows the scooter 10 with the front wheel 14 having been turned by pivoting of the first foot support 12b in a first, (e.g. counterclockwise) foot support pivot direction from its neutral position by the rider R. FIG. 9 is a transparent top plan view so as to show elements such as elements 20 and 54 which would otherwise be obscured by the first foot support 12b. As can be seen, pivoting of the first foot support 12b in the first foot support pivot direction causes pivoting of the front wheel 14 in a first front wheel pivot direction to steer the scooter 10 in a first turning direction. FIG. 10 is similar to FIG. 9 but shows the scooter 10 with the front wheel 14 having been turned by pivoting of the first foot support 12b in a second, (e.g. clockwise) foot support pivot direction from its neutral position by the rider R, which causes pivoting of the front wheel 14 of the scooter 10 in a second front wheel pivot direction to steer the scooter 10 in a second turning direction.

While the term ‘scooter’ has been used in the present disclosure, it will be understood that the term is an example only and that the presently disclosed features may be more broadly applicable to other electric vehicles and other vehicles in general, such as any suitable vehicle with a front wheel and a rear wheel and a body therebetween that connects them.

The above-described embodiments are intended to be examples only, and alterations and modifications may be carried out to those embodiments by those of skill in the art.

While the control system described herein is shown and described as including a single controller (i.e. controller 36), it will be appreciated that the control system can include two or more physical controllers in communication with each other. Accordingly, while the embodiment shows the various components of the computer system residing on the same physical computer, those skilled in the art will appreciate that the components can reside on separate physical computers.

Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1. An electric vehicle comprising:
a steering wheel, a driving wheel, and a main body portion that is part of a body, wherein the body is positioned to support a rider and connects to the steering wheel and the driving wheel, wherein the body defines a longitudinal axis for the electric vehicle;
a motor connected to the driving wheel and a power source connected to the motor;
a steering linkage positioned for controlling pivoting movement of the steering wheel; and
a speed control input device for controlling the rotation of the driving wheel, wherein the body includes a main body portion and a first foot support that is movably supported on the main body portion, and is connected to the steering linkage such that movement of the first foot support by a foot of the rider drives the steering linkage to pivot the steering wheel so as to steer the electric vehicle.

2. The electric vehicle of claim 1, wherein the main body portion has a lateral width and wherein the first foot support is movable between an open position in which the first foot support is connected to the steering linkage, and a closed position in which the first foot support has a lateral width that is less than two times the lateral width of the main body portion.

3. The electric vehicle of claim 2, wherein, in the closed position, the first foot support has a lateral width that is not more than the lateral width of the platform.

4. The electric vehicle of claim 1, wherein the speed control input device is a second foot support that is supported on the main body portion for supporting a second foot of the rider.

5. The electric vehicle of claim 4, wherein the second foot support is movable between a closed and an open position, and, wherein, in the open position, the second foot support is operable by the second foot of the rider to control a speed of rotation of the driving wheel, and wherein, in the closed position, the second foot support has a lateral width that is less than two times the lateral width of the main body portion.

6. The electric vehicle of claim 5, wherein, in the closed position, the first foot support has a lateral width that is not more than the lateral width of the platform.

7. The electric vehicle of claim 4, wherein the second foot support communicates input from the second foot of the rider wirelessly to a control system that controls driving of the motor.

8. The electric vehicle of claim 1, wherein the vehicle includes a balance drive for balancing of the vehicle and at least one balance sensor that outputs signals based on an orientation of the electric vehicle, and
a control system that is programmed to control balance of the electric vehicle based on signals from the at least one balance sensor.

9. The electric vehicle of claim 9, wherein the at least one balance sensor is mounted inside the driving wheel.

11. The electric vehicle of claim 10, wherein the at least one balance sensor is mounted inside the steering wheel.

12. The electric vehicle of claim 11, wherein the stabilizing means are used to control the steering wheel.

13. The electric vehicle of claim 8, wherein the stabilizing means is a control moment gyroscope.

14. An electric vehicle, comprising:
a body;
a plurality of wheels including at least one front wheel and at least one rear wheel;
a motor that is operatively connected to at least one of the plurality of wheels; and
at least one battery for storing power to be sent to the motor to drive the at least one of the plurality of wheels,
wherein the body includes a main body portion, a first foot support and a second foot support, wherein the first and second foot supports each are positionable in a stowage position wherein each of the first and second foot supports have a width that is less than two times a width of the main body portion, and a use position in which each of the first and second foot supports have a width that is greater than the width of the first and second foot supports when in the stowage position.

15. An electric vehicle, comprising:
a body including a main body portion, a first foot support supported on the main body portion, and a second support positioned aft of the first foot support and supported on the main body portion;
a plurality of wheels including at least one front wheel and at least one rear wheel;
a motor that is operatively connected to at least one of the plurality of wheels;
at least one battery for storing power to be sent to the motor to drive the at least one of the plurality of wheels;
a balancing drive that includes at least one CMG and/or at least one reaction wheel;
at least one balance sensor that outputs signals based on an orientation of the electric vehicle;
a control system that is programmed to control balance of the electric vehicle based on signals from the at least one balance sensor.
